(19) United States
(12) Patent Application Publication
(10) Pub. No.: US 2020/0062650 A1
(43) Pub. Date: Feb. 27, 2020

(54) HYDRAULIC BINDER FOR MORTAR, HAVING A LOW CARBON FOOTPRINT, AND MORTAR CONTAINING SUCH A HYDRAULIC BINDER

(71) Applicants: Philippe Dhervilly, Cresserons (FR); Daniel Rivard, Paris (FR)

(72) Inventors: Philippe Dhervilly, Cresserons (FR); Daniel Rivard, Paris (FR)

(21) Appl. No.: 16/493,106

(22) PCT Filed: Feb. 15, 2018
(86) PCT No.: PCT/FR2018/050370

§ 371 Date: Sep. 11, 2019

(30) Foreign Application Priority Data
Mar. 16, 2017 (FR) 1752140

(51) Int. Cl. C04B 28/08; C04B 14/26; C04B 14/04; C04B 22/12; C04B 22/14

(52) U.S. Cl. CPC C04B 28/082; C04B 14/26; C04B 22/143; C04B 22/124; C04B 14/043

(57) ABSTRACT

The invention relates to a low-carbon-footprint hydraulic binder for mortar, and to mortar containing such a hydraulic binder. The hydraulic binder for mortar comprises at least 60% steel slag and at least one catalyst.

The present invention relates to a hydraulic binder for mortar, as well as a mortar containing such a hydraulic binder.

In the scope of the present invention, by hydraulic binder it is meant a mineral material which, mixed with water, forms a paste which sets and hardens as a result of reactions and processes of hydration, and which retains its strength and its stability after hardening, even under water. This hydraulic binder is intended to be used to produce a mortar.

From document EP-1 775 270, a hydraulic binder is known having a particular composition of consistencies in very precise respective proportions. This hydraulic binder makes it possible to generate high strengths from the first hours. However, it does not appear particularly ecological.

To obtain a more ecological binder, in particular via waste enhancement, one can be led to use industrial waste.

Thus using blast furnace slag to produce a hydraulic binder is known. In the steel industry, a slag is dross which is formed during melting or production of metals via liquid means.

However, such hydraulic binders based on blast furnace slag also have an increased carbon footprint.

The present invention aims to overcome this disadvantage, by proposing a hydraulic binder for mortar, particularly ecological, with a very favourable carbon footprint and energy balance.

To this end, according to the invention, the hydraulic binder comprises at least 60% steel slag and at least one catalyst (or activator).

Thus, thanks to the use of slag coming from steelworks, it is made possible to obtain a hydraulic binder having a much reduced carbon footprint.

As an illustration, the carbon footprint (in kilograms, equivalent to CO₂ per tonne) is ten times less for a hydraulic binder according to the invention used as a road hydraulic binder, than a road hydraulic binder based on blast furnace slag.

The usual practice and the prior art is not to use steel slag to form hydraulic binders, in particular due to disadvantages such as risks of swelling. The slag coming from a steelwork is generally more complex than a blast furnace slag and contains impurities and undesirable chemical elements by absorbing oxide inclusions dissolved in the metal.

The hydraulic binder in accordance to the invention with a steel slag base makes it possible to produce mortars with low or average strengths, intended mainly to form surface grounds, in particular roads. The strength obtained by the hydraulic binder in accordance to the invention is sufficient for such applications.

The present invention thus makes it possible to enhance steel slags which have a waste volume which is highly detrimental for steelworks.

Advantageously, said catalyst of the hydraulic binder comprises at least one of the following components:
sodium silicate;
sodium sulphate;
calcium chloride;
calcium sulphate;
sodium carbonate;
magnesium;
ultrafine limestone.

The present invention also relates to a mortar formed from at least one hydraulic binder, an aggregate and water, said hydraulic binder being such as that mentioned above.

Advantageously, the mortar comprises a percentage of hydraulic binder by weight comprised between 5% and 15%.

Moreover, in a preferred embodiment:
said mortar is of the self-placing type; and/or
said aggregate comprises excavated materials of worksite.

The invention will be better understood, and other aims, details, features and advantages of it will appear more clearly during the following explanatory description.

The hydraulic binder which is intended to be used to produce a mortar comprises therefore at least 60% of steel slag and at least one catalyst (or activator). This hydraulic binder has a very low carbon footprint.

In a particular embodiment, said catalyst comprises one or more of the following components:
sodium silicate;
sodium sulphate;
calcium chloride;
calcium sulphate;
sodium carbonate;
magnesium;
ultrafine limestone.

The present invention also relates to a mortar formed from at least one hydraulic binder, an aggregate and water.

The mortar comprises a percentage of hydraulic binder by weight comprised between 5% and 15%, and preferably of the order of 7%.

By using steel slag, the present invention goes against the usual practice and the prior art, which do not use steel slag to form hydraulic binders, in particular due to disadvantages such as risks of swelling.

The hydraulic binder according to the invention with a steel slag base makes it possible to produce mortars with low or average strengths, intended mainly to be used to form surface grounds, in particular roads. The strengths obtained by the hydraulic binder in accordance to the invention are sufficient for such applications.

The present invention thus makes it possible to enhance steel slags which have a very detrimental waste volume.

Furthermore, due to the features of the hydraulic binder, the mortar retains the natural colour of the aggregate used.

Moreover, in a preferred embodiment, said aggregate comprises excavated materials of worksite. It can be any type of worksite, and in particular, a cable-laying or pipework worksite. The mortar can in particular be produced and reused directly on the worksite where materials are produced, which in particular avoids having to dump materials which are thus used and enhanced.

Consequently, a particularly ecological mortar is obtained, which makes it possible to effectively enhance two types of waste, namely steel slag to form the hydraulic binder and excavated materials of worksite, used as aggregates.

Although not exclusively, the hydraulic binder in accordance to the invention is more particularly suitable for forming self-placing mortars. A self-placing mortar is a mortar which is capable, under the sole effect of gravity, to put itself into place in spaces intended to receive it, either spaces produced and which are removable, such as formwork, or natural spaces such as trenches, for example, these spaces being able to be complex and cumbersome.

1. A hydraulic binder for mortar,
comprising at least 60% steel slag and at least one catalyst.

2. The hydraulic binder according to claim 1,
wherein said catalyst comprises at least one of the following components:
sodium silicate;
sodium sulphate;
calcium chloride;
calcium sulphate;
sodium carbonate;
magnesium; or
ultrafine limestone.

3. A mortar formed from at least one hydraulic binder, an aggregate and water,
wherein the hydraulic binder is the hydraulic binder according to claim 1.

4. The mortar according to claim 3,
comprising between 5% and 15% by weight of hydraulic binder.

5. The mortar according to claim 3,
wherein the mortar is a self-placing type mortar.

6. The mortar according to claim 3,
wherein said aggregate comprises excavated materials of worksite.
